(19) United States
(12) Patent Application Publication
(10) Pub. No.: US 2012/0129376 A1
(43) Pub. Date: May 24, 2012

(54) ELECTRICAL CONNECTOR

(75) Inventor: Yong-Teck YANG, Singapore (SG)

(73) Assignee: Molex Incorporated, Lisle, IL (US)

(21) Appl. No.: 13/303,277

(22) Filed: Nov. 23, 2011

(30) Foreign Application Priority Data
Nov. 23, 2010 (SG) 201008581-9

(51) Int. Cl. H01R 13/62

(52) U.S. Cl. 439/325

(57) ABSTRACT

An electrical connector comprises a main body, a pair of first arm members extending from two opposite ends of the main body, and a pair of second arm members extending from the two opposite ends of the main body. The main body includes a front side having a lower region extending between the pair of first arm members and an upper region extending between the pair of second arm members, a first receiving slot formed on the lower region, and a second receiving slot formed on the upper region. Each of the first and second arm members includes an interfering portion, wherein the interfering portion of the second arm member is able to engage with the interfering portion of the respective first arm member when the respective first arm member moves toward an unlatched position.

### RELATED APPLICATIONS

This application claims priority to Singapore Application No. 201008581-9, filed Nov. 23, 2010, which is incorporated herein by reference in its entirety.

### TECHNICAL FIELD

The present invention relates to an electrical connector, and more particularly, to an electrical connector configured for receiving multiple electronic devices arranged in a stacking manner.

### DESCRIPTION OF THE RELATED ART

Motherboards of electronic apparatuses carry electronic components, such as processors, memories, active and passive electronics, connectors (for connecting mated connectors, electronic card modules, electronic devices or power sources), and wires for interconnecting the electronic components and the connectors. With the help of the motherboards, electronic components can perform their desired functions.

The mounting area of a motherboard is limited. As motherboards become smaller, or more electronic components and connectors are mounted on motherboards, one solution for the efficient use of the mounting area of a motherboard is stacking the electronic components or the connectors. FIG. 1 shows a conventional electrical connector 1 which allows connection of two electronic card modules stacked one upon another to a motherboard so as to double the mounting area of a conventional electrical connector receiving a single electronic device.

The electrical connector 1 includes a lower housing 11 and an upper housing 12. The lower housing 11 has a card receiving slot 111 for receiving an electronic device and a pair of flexible arms 112 for latching an inserted electronic device. In the same manner, the upper housing 12 has a card receiving slot 121 for receiving an electronic device and a pair of flexible arms 122 for latching an inserted electronic device. As can be seen in FIG. 1, the upper flexible arm 122 is above and extends parallel to the lower flexible arm 112, and the flexible arm 112 and the flexible arm 122 are independently operative.

However, such an electronic device stack electrical connector 1 with independently operative flexible arms 112 and 122 has several disadvantages. One major disadvantage is that users can directly unlatch and remove the electronic device received at the lower card receiving slot 111 while the electronic device received at the upper card receiving slot 121 is inserted. Such an operation may damage the inserted upper electronic device. Another disadvantage is that the lower and upper electronic devices may collide when both are simultaneously unlatched.

### SUMMARY OF THE INVENTION

In an embodiment an electrical connector comprises a main body, a pair of first arm members, and a pair of second arm members. The main body includes two opposite ends, a front side having a lower region and an upper region, a first receiving slot formed on the lower region, and a second receiving slot formed on the upper region. The pair of first arm members extend respectively from the two opposite ends of the main body, and the lower region extends between the pair of first arm members. The pair of second arm members extend respectively from the two opposite ends of the main body, and the upper region extends between the pair of second arm members. Each first arm member includes an interfering portion. Each second arm member also includes an interfering portion, which is able to engage with the interfering portion of the respective first arm member when the respective first arm member moves toward an unlatched position.

### BRIEF DESCRIPTION OF THE DRAWINGS

The invention will be described according to the appended drawings in which:

FIG. 1 shows a conventional electrical connector;

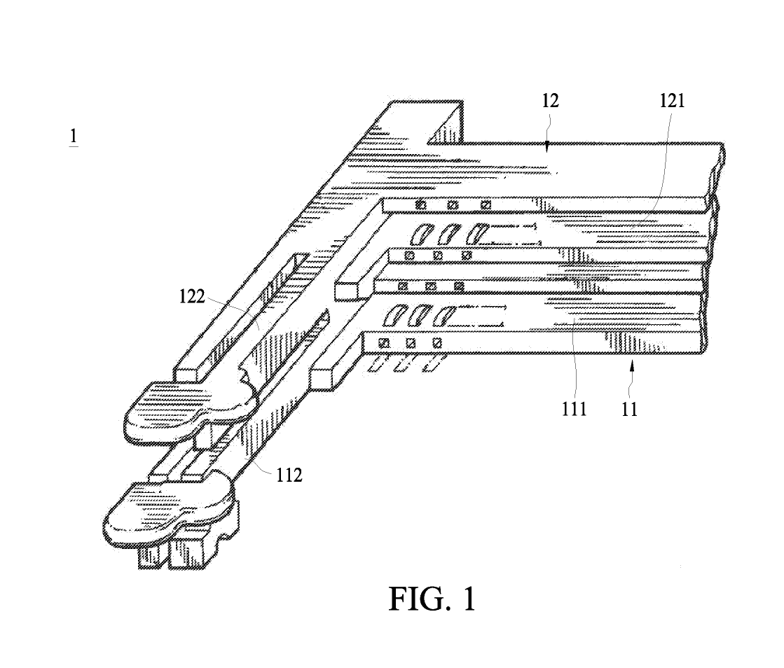

FIG. 2 is a perspective view showing a electrical connector mounted on a printed circuit board and receiving two electronic devices positioned in a stacked manner according to one embodiment;

FIG. 3A is a perspective view showing an electrical connector according to one embodiment;

FIG. 3B is a sectional view showing the terminals arranged in the main body of an electrical connector according to one embodiment;

FIG. 4 is a top view of the electrical connector in FIG. 3;

FIG. 5 is a perspective view of an electrical connector with its second arm members in an unlatched position according to one embodiment;

FIG. 6 is a top view of the electrical connector in FIG. 5;

FIG. 7 is a fragmentary perspective view showing the latch elements, the pressing portions, and the interfering portions of the first and second arm members of an electrical connector according one embodiment;

FIG. 8 is another fragmentary perspective view showing the latch elements, the pressing portions, and the interfering portions of the first and second arm members of an electrical connector according one embodiment;

FIG. 9 is a top view showing the first and second arm members of an electrical connector in an unlatched position according to one embodiment;

FIG. 10 is a perspective view showing that two unlatched electronic devices obliquely inserted in an electrical connector with first and second arm members in unlatched positions according to one embodiment;

FIG. 11 demonstrates the engagement between the pressing portion of the first arm member of an electrical connector and the card edge portion of an electronic device according to one embodiment;

FIG. 12 demonstrates the engagement between the pressing portion of the second arm member of an electrical connector and the card edge portion of an electronic device according to one embodiment;

FIG. 13 is a perspective view showing an electrical connector according to another embodiment;

FIG. 14 is a sectional view showing the internal arrangement of the electrical connector in FIG. 13; and

FIG. 15 is a perspective exploded view of the electrical connector in FIG. 13.

### DETAILED DESCRIPTION OF THE INVENTION

Hereinafter, embodiments of the present invention are described in detail with reference to the attached drawings.

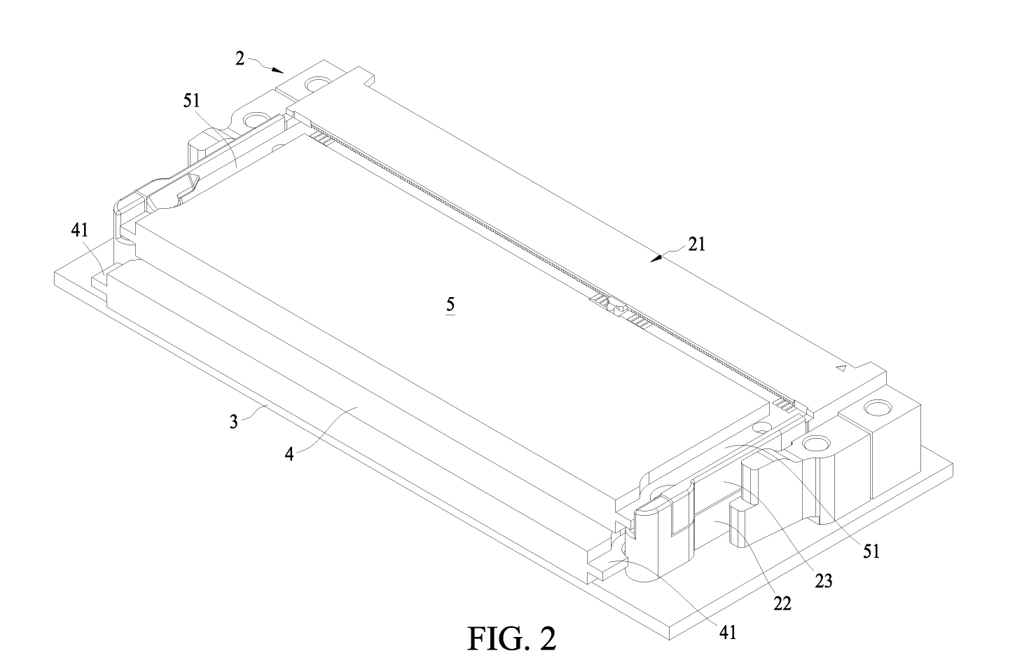

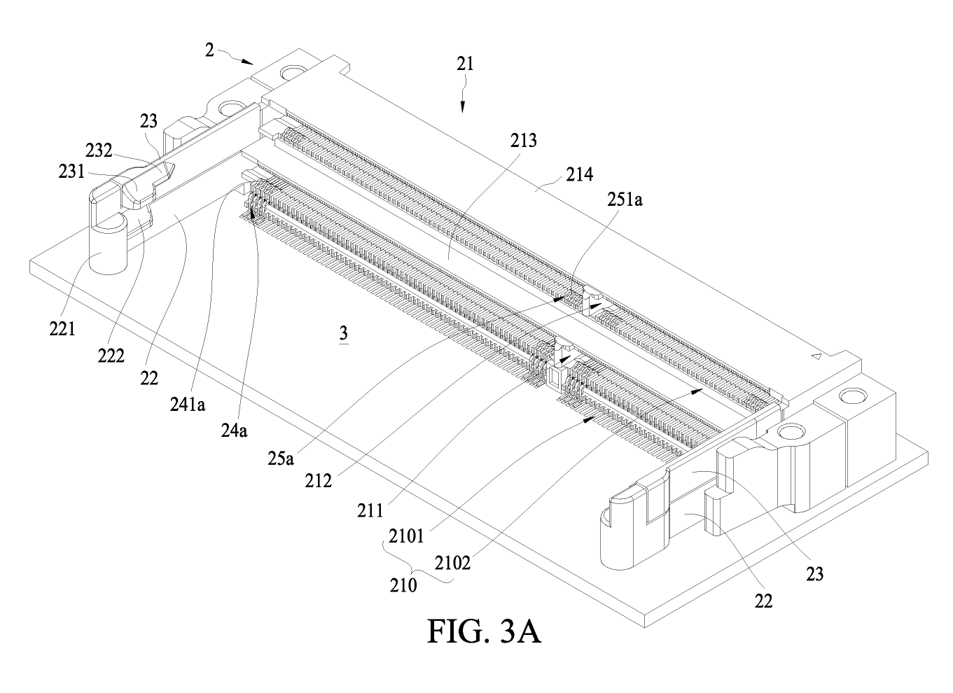

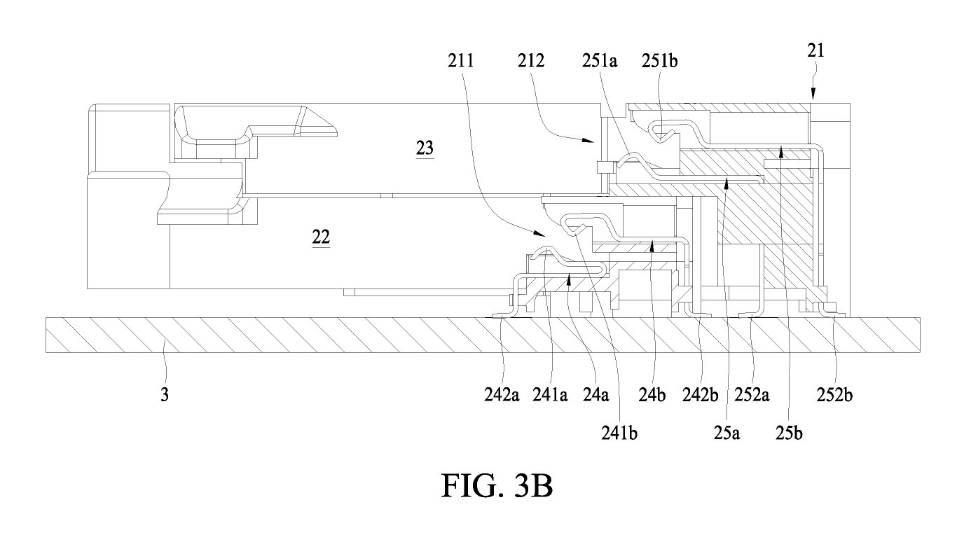

In FIG. 2, the electrical connector 2 in accordance with one embodiment is mountable to a printed circuit board 3 for receiving stacked horizontally positioned electronic devices 4 and 5 such as electronic card modules. As shown in FIGS. 2 and 3, the electrical connector 2 comprises a main body 21 having two opposite ends, a pair of first arm members 22 extending forward from the two opposite ends of the main body 21, and a pair of second arm members 23 extending forward from the two opposite ends of the main body 21. The main body 21 includes a front side 210 having a lower region 2101 extending between the pair of first arm members 22 and an upper region 2102 extending between the pair of second arm members 23, a first receiving slot 211 formed on the lower region 2101 for receiving the front edge portion of the electronic device 4, and a second receiving slot 212 formed on the upper region 2102 for receiving the front edge portion of the electronic device 5.

In one embodiment, the main body 21 includes two housings 213 and 214, wherein the pair of first arm members 22 extend from two opposite ends of the housing 213, and the pair of second arm members 23 extend from two opposite ends of the housing 214. The two housings 213 and 214 can be separated or formed integrally.

In one embodiment, the first and second arm members 22 and 23 can be made of plastic material.

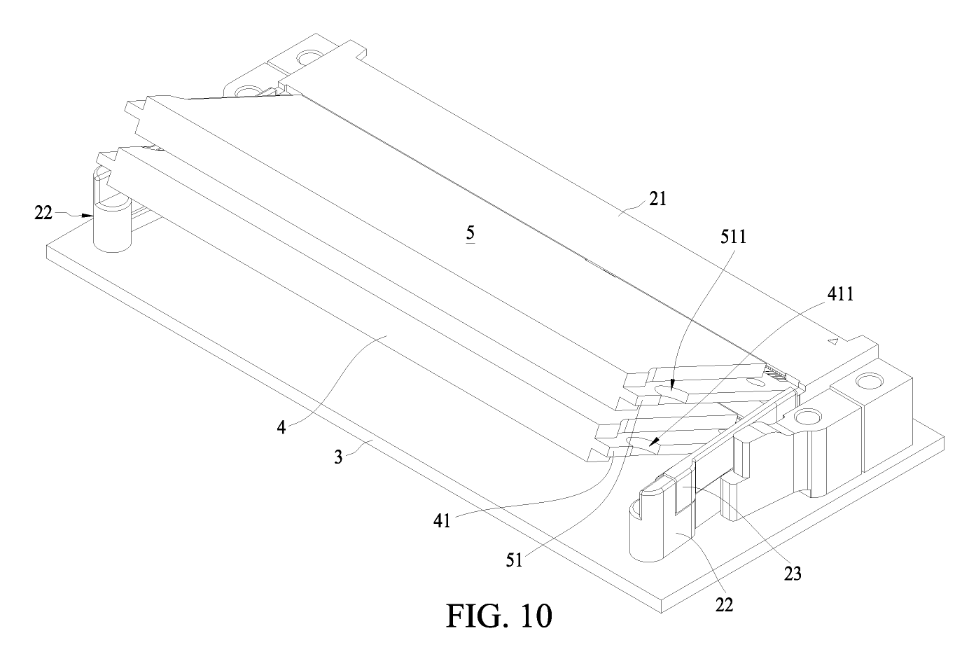

As shown in FIG. 2, each electronic device 4 or 5 may comprise two opposite side edge portions 41 or 51 and a front edge portion. A notch 411 or 511 (as shown in FIG. 10) is formed on each side edge portion 41 or 51, and a plurality of contact pads are arrayed on the front edge portion. Referring to FIGS. 2 to 4, the two first arm members 22 define a space to accommodate the electronic device 4. Each first arm member 22 includes a latch element 221 fit into the respective notch 411 on the side edge portion 41 of an inserted electronic device 4 so as to prevent the inserted electronic device 4 from being accidentally pulled out. Each first arm member 22 further comprises a pressing portion 222 protruding inward from an inner side surface of the first arm member 22 to hold the electronic device 4 in an inserted position as shown in FIG. 2. The pressing portion 222 is engageable with the top surface of the respective side edge portion 41 of an inserted electronic device 4 so as to counteract spring forces exerted by the compressed contact portions 241a and 241b of the lower and upper terminals 24a and 24b (as shown in FIG. 3B) arranged along the first receiving slot 211 and to hold the electronic device 4 in an inserted position.

In the same manner, the two second arm members 23 define a space to accommodate the electronic device 5 as shown in FIG. 2. Each second arm member 23 includes a latch element 231 fit into the respective notch on the side edge portion 51 of an inserted electronic device 5 so as to prevent the inserted electronic device 5 from being accidentally pulled out. Each second arm member 23 further comprises a pressing portion 232 protruding inward from an inner side surface of the second arm member 23 to hold the electronic device 5 in an inserted position as shown in FIG. 2. The pressing portion 232 is engageable with the top surface of the respective side edge portion 51 of an inserted electronic device 5 so as to counteract spring forces exerted by the compressed contact portions 251a and 251b of the lower and upper terminals 25a and 25b (as shown in FIG. 3B) arranged along the second receiving slot 212 and to hold the electronic device 5 in an insertion position.

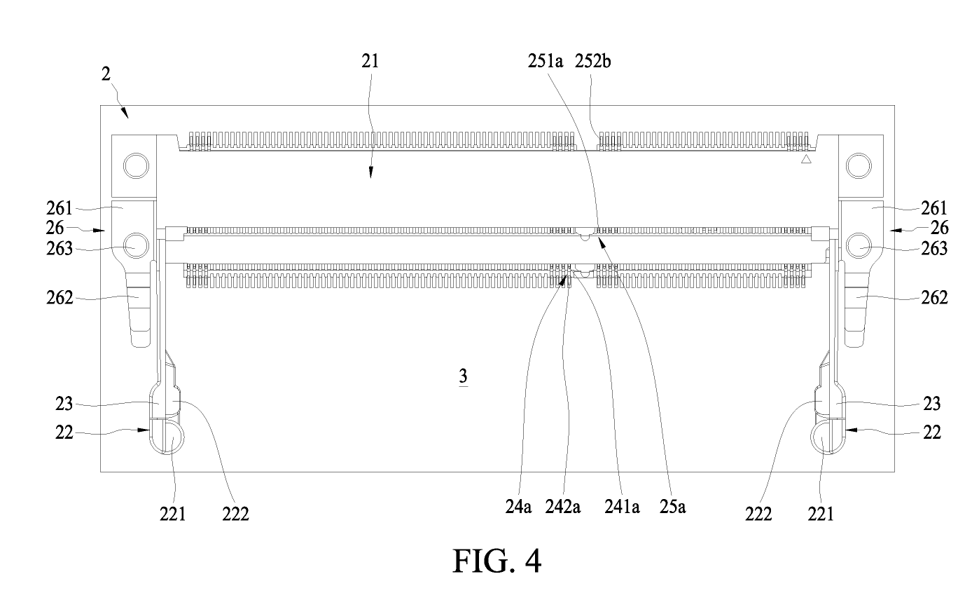

Referring to FIGS. 3A, 3B and 4, each of the lower and upper terminals 24a and 24b includes a contact portion 241a and 241b and a solder portion 242a and 242b configured to be solderable to the printed circuit board 3. The lower terminals 24a are arranged along the first receiving slot 211 with their contact portions 241a partially protruding in the first receiving slot 211 for electrically engaging the contact pads on one surface of the front edge portion of the electronic device 4, and the upper terminals 24b are arranged along the first receiving slot 211 with their contact portions 241b partially protruding in the first receiving slot 211 for electrically engaging the contact pads on an opposite surface of the front edge portion of the electronic device 4.

Similarly, each of the lower and upper terminals 25a and 25b includes a contact portion 251a and 251b and a solder portion 252a and 252b configured to be solderable to the printed circuit board 3. The lower terminals 25a are arranged along the second receiving slot 212 with their contact portions 251a partially protruding in the second receiving slot 212 for electrically engaging the contact pads on one surface of the front edge portion of the electronic device 5, and the upper terminals 25b are arranged along the second receiving slot 212 with their contact portions 251b partially protruding in the second receiving slot 212 for electrically engaging the contact pads on an opposite surface of the front edge portion of the electronic device 5.

In one embodiment, the printed circuit board 3 comprises a plurality of contact pads corresponding to the lower and upper terminals 24a, 24b, 25a and 25b, and the solder portions 242a, 242b, 252a and 252b are adapted to be surface-mounted on the respective contact pads on the printed circuit board 3.

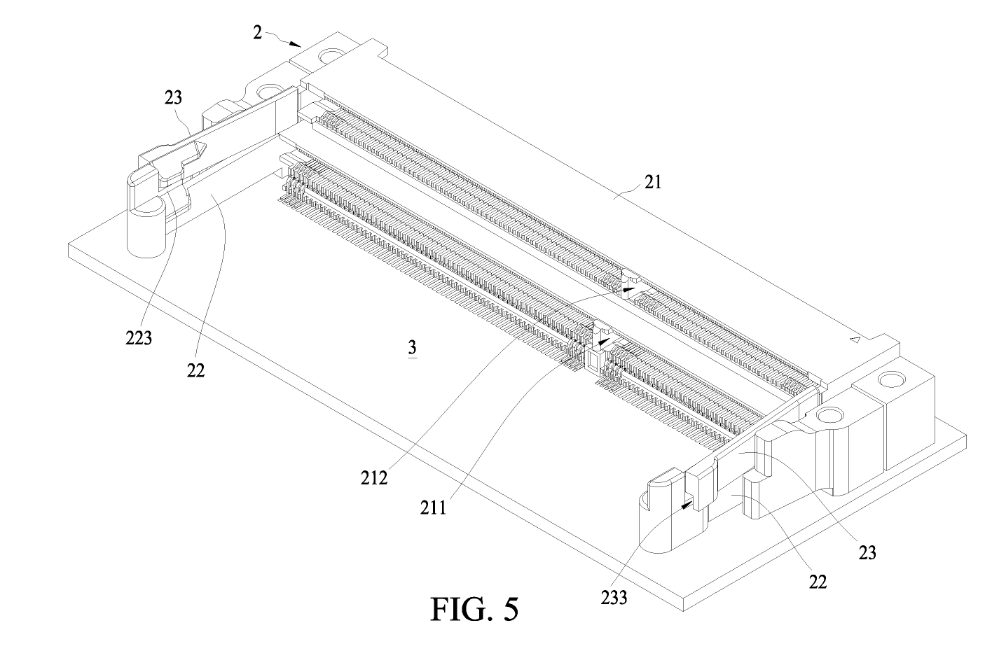

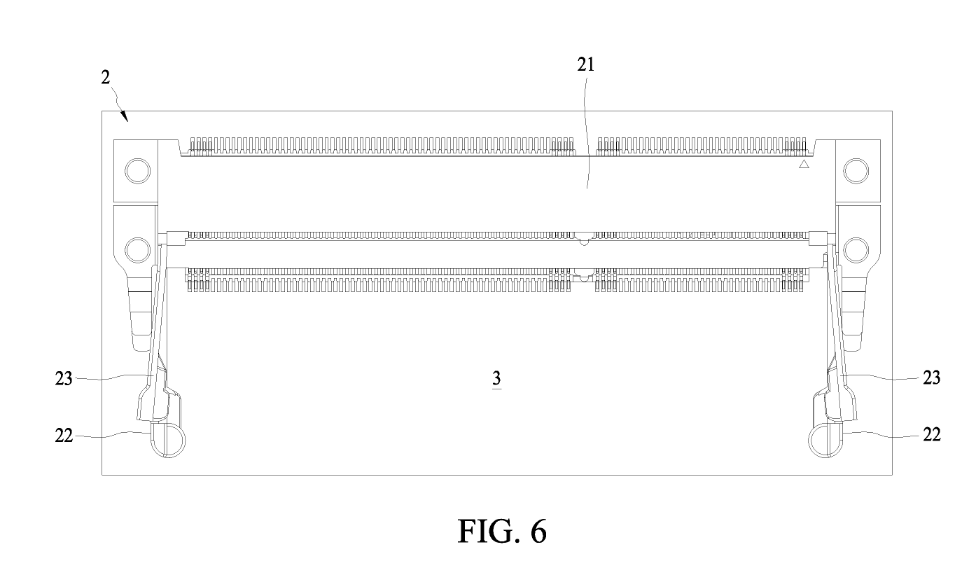

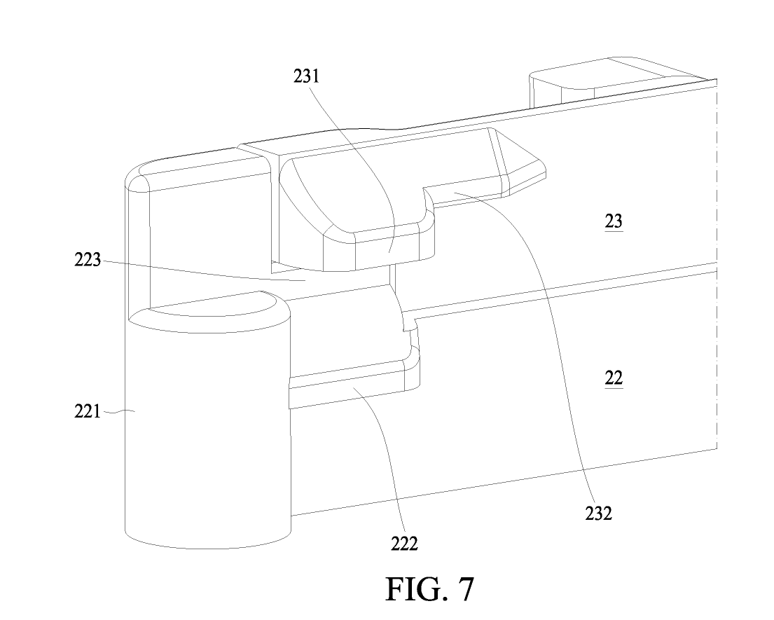

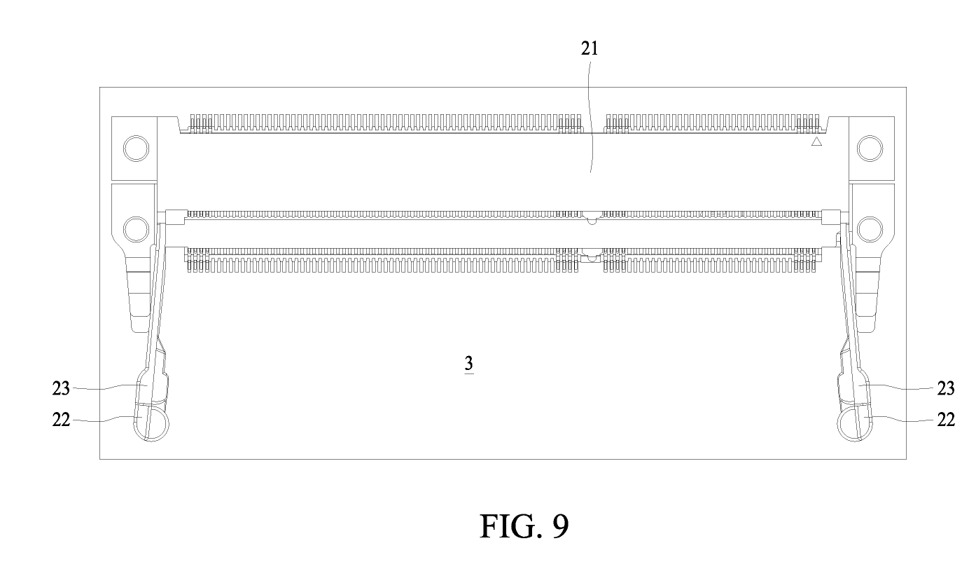

The adjacent first and second arm members 22 and 23 are fundamentally separated. As illustrated in FIGS. 5 and 6, the second arm member 23 can move to an unlatched position while the first arm member 22 is in a latched position. As such, an electronic device can be inserted in or removed from the second receiving slot 212 without touching the electronic device inserted in the first receiving slot 211. However, as shown in FIGS. 5, 7, and 8, each of the first and second arm members 22 and 23 includes an interfering portion 223 or 233. The interfering portions 223 and 233 of two adjacent first and second arm members 22 and 23 are designed to be engageable with one another when the first arm member 22 moves toward an unlatched position. As shown in FIGS. 9 and 10, with the cooperation of the interfering portions 223 and 233 of two adjacent first and second arm members 22 and 23, the movement of the first arm member 22 to an unlatched position may simultaneously bring the second arm member 23 to an unlatched position as shown in FIG. 9 so that the electronic devices 4 and 5 can be simultaneously turned upward by spring forces exerted by the compressed contact portions 241a, 241b, 251a and 251b of the lower and upper terminals 24a, 24b, 25a and 25b. Such a design can prevent the situation where the electronic device 4 inserted in the lower first receiving slot 211 is removed while the electronic device 5 inserted in the upper second receiving slot 212 is still in an inserted position.

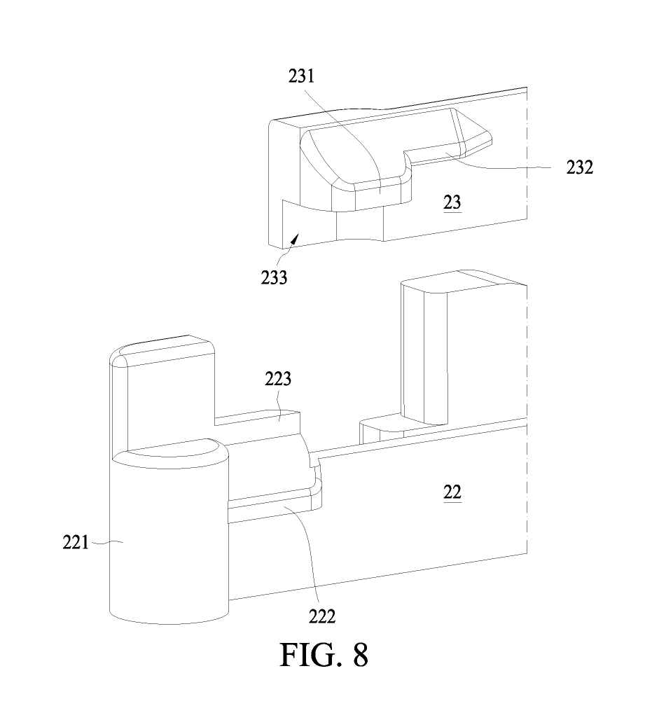

In the embodiment in FIG. 8, the interfering portion 223 of the first arm member 22 projects upward to be adjacent to the inner side of the interfering portion 233 of the second arm member 23 such that when the first arm member 22 moves toward an unlatched position, the interfering portion 223 can engage the interfering portion 233. In one embodiment, the interfering portion 233 can be shaped to mate with the configuration of the interfering portion 223 so that the adjacent first and second arm members 22 and 23 can be vertically aligned.

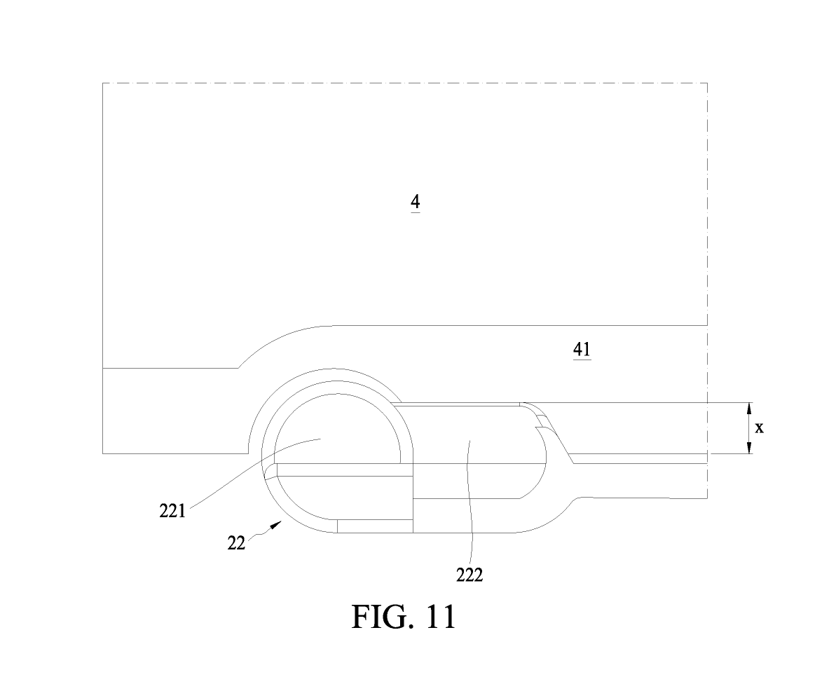

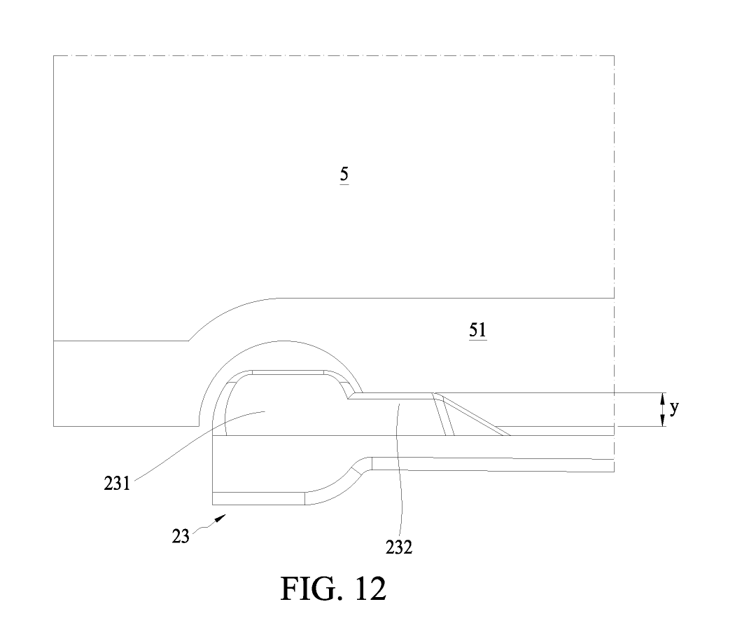

Referring to FIGS. 11 and 12, the electrical connector 2 permits the upper electronic device 5 in FIG. 2 to be turned upward ahead of the lower electronic device 4 in FIG. 2. To this end, the distance x between the inward edge of the pressing portion 222 of each first arm member 22 and the adjacent edge of the side edge portion 41 of an inserted electronic device 4 is greater than the distance y between the inward edge of the pressing portion 232 of each second arm member 23 and the adjacent edge of the side edge portion 51 of an inserted electronic device 5 so that during the movement of the first arm member 22 toward an unlatched position, the pressing portion 232 of the second arm member 23 disengages from the respective side edge portion 51 of the inserted electronic device 5 prior to the disengagement of the pressing portion 222 of each first arm member 22 and the respective side edge portion 41 of the inserted electronic device 4. As such, the upper electronic device 5 is turned upward before the lower electronic device 4, and the collision between the two electronic devices 4 and 5 can be avoided.

Referring to FIG. 4, the electrical connector 2 also comprises a pair of arm member protectors 26 for limiting the unlatching movement of the first and second arm members 22 and 23 so as to prevent the first and second members 22 and 23 from being over-bent, avoiding damage to the first and second members 22 and 23. Each arm member protector 26 includes a base portion 261 adjacent to the respective end of the main body 21 and an extending portion 262 adjacent to and spaced apart from the respective one of the first and second members 22 and 23. A screw element 263 can be applied to fasten the base portion 261 to the printed circuit board 3 so that the arm member protector 25 can be completely secured.

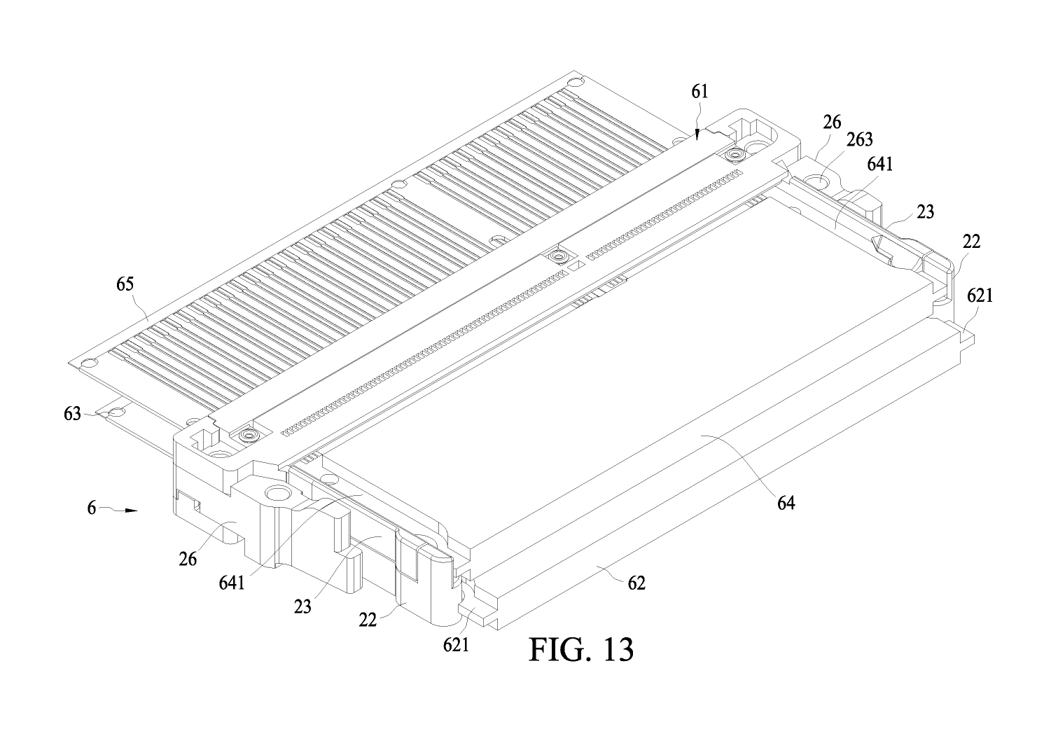

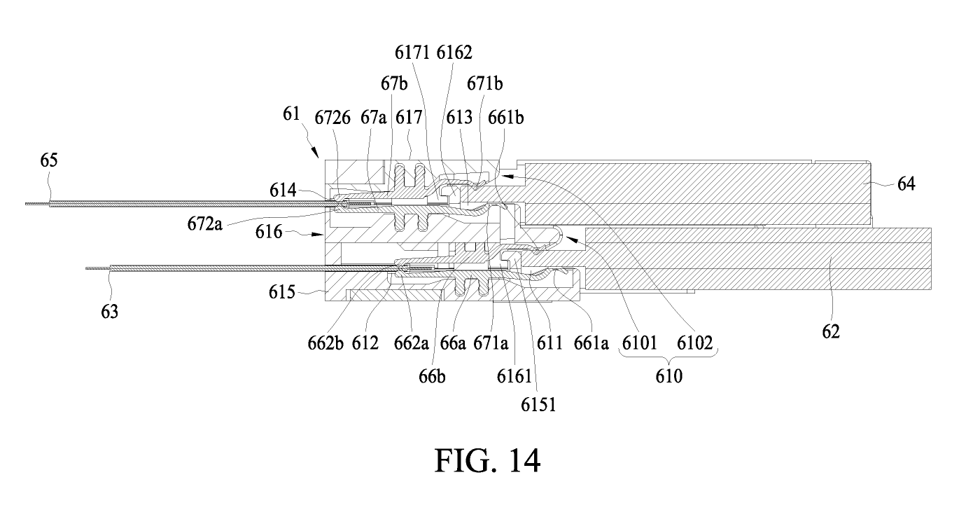

Features as disclosed herein can be used in another type of electrical connector 6 as shown in FIGS. 13 to 15. The electrical connector 6 comprises a main body 61 having two opposite ends, a pair of first arm members 22 extending forward from the two opposite ends, and a pair of second arm members 23 extending forward from the two opposite ends. In FIG. 14, the main body 61 includes a front side 610 having a lower region 6101 and an upper region 6102, a first lower receiving slot 611 formed on the lower region 6101 for receiving an electronic device 62, a second lower receiving slot 612 formed opposite to the first lower receiving slot 611 for receiving an electronic device 63, a first upper receiving slot 613 formed on the upper region 6102 for receiving an electronic device 64, and a second upper receiving slot 614 opposite to the first upper receiving slot 613 for receiving an electronic device 65.

In one embodiment, the electronic devices 62 and 64 can be card edge modules or daughter cards, and the electronic devices 63 and 65 can be flexible circuit devices such as flexible flat cables, flexible printed circuit boards, or mother cards.

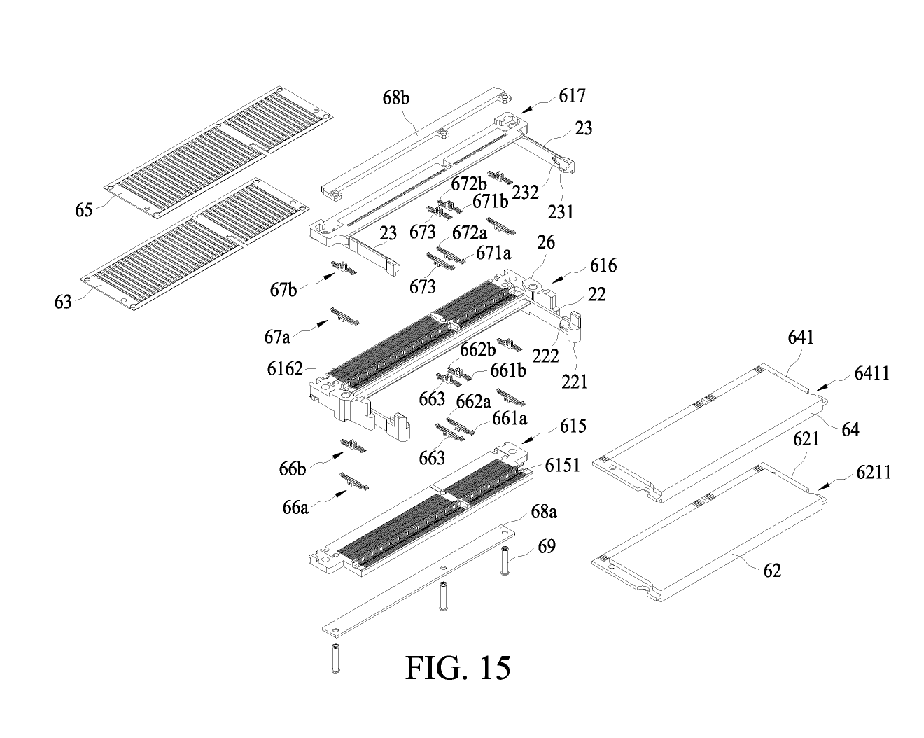

As shown in the embodiment of FIG. 15, the main body 61 may comprise a lower housing 615, a middle housing 616 disposed on the lower housing 615, and an upper housing 617 disposed on the middle housing 62. The pair of first arm members 22 extend from two opposite ends of the middle housing 616, and the pair of second arm members 23 extend from two opposite ends of the upper housing 617. Referring back to FIG. 14, the lower housing 615 and the middle housing 616, in combination, define the first and second lower receiving slots 611 and 612. The upper housing 617 and the middle housing 616, in combination, define the first and second upper receiving slots 613 and 614.

Referring to FIGS. 13 and 15, each of the first and second arm members 22 and 23 includes a latch element 221 or 231 fit into the respective notch 6211 or 6411 on the side edge portion 621 or 641 of the electronic device 62 or 64 for latching the electronic device 62 or 64. In addition, each of the first and second arm members 22 and 23 includes a pressing portion 222 or 232 protruding inward from the inner side surface of the first or second arm member 22 or 23 to hold the electronic device 62 or 64 in an inserted position.

As shown in FIGS. 14 and 15, the electrical connector 6 comprises a plurality of first lower and upper terminals 66a and 66b each including a first contact portion 661a or 661b and a second contact portion 662a and 662b, and a plurality of second lower and upper terminals 67a and 67b each including a first contact portion 671a or 671b and a second contact portion 672a and 672b. The first contact portions 661a and 661b of the lower and upper terminals 66a and 66b are arranged along the first lower receiving slot 611 and configured for electrically engaging a first type of electronic device 62. The second contact portions 662a and 662b of the first lower and upper terminals 66a and 66b are arranged along the second lower receiving slot 612 and configured for electrically engaging a second type of electronic device 63. The first contact portions 671a and 671b of the second lower and upper terminals 67a and 67b are arranged along the first upper receiving slot 613 and configured for electrically engaging another first type of electronic device 64. The second contact portions 672a and 672b of the second lower and upper terminals 67a and 67b are arranged along the second upper receiving slot 614 and configured for electrically engaging another second type of electronic device 65. In one embodiment, each of the first lower and upper terminals 66a and 66b and the second lower and upper terminals 67a and 67b can have a transverse protrusion 663 or 673 insertable into the respective one of the lower, middle, and upper housings 615, 616, and 617 so that the first lower and upper terminals 66a and 66b and the second lower and upper terminals 67a and 67b can be securely held.

In one embodiment, the first type of electronic device 62 and 64 is a card edge module or a daughter card, and the second type of electronic device 63 and 65 is a flexible flat cable, flexible printed circuit board or mother card.

Referring to FIG. 15, the electrical connector 6 may include lower and upper bracket members 68a and 68b clamping the lower, middle, and upper housings 615, 616, and 617 together for fastening the lower, middle, and upper housings 615, 616, and 617. The lower and upper bracket members 68a and 68b can be secured by a plurality of fasteners 69 such as screws or rivets penetrating through the assembled lower, middle, and upper housings 615, 616, and 617.

In one embodiment, the lower and upper bracket members 68a and 68b can be components distinct from the lower and upper housings 615 and 617. The separated upper bracket member 68b, lower bracket member 68a, upper housing 617, and lower housing 615 can be easily manufactured. In an alternative embodiment, the upper bracket member 68b and the upper housing 617 can be formed integrally by an insert-molding process, and the lower bracket member 68a and the lower housing 615 can be formed integrally by an insert-molding process. As such, fewer components of the electrical connector 6 are needed, simplifying the manufacturing and assembling processes.

Referring to FIGS. 13 and 15, the electrical connector 6 may further comprise a pair of arm member protectors 26, similar to those of the embodiment in FIG. 4, for limiting the unlatching movement of the first and second arm members 22 and 23 so as to prevent the first and second members 22 and 23 from being over-bent, avoiding damage to the first and second members 22 and 23. A screw element 263 can be applied to fasten the arm member protector 26 to a printed circuit board.

Referring to FIGS. 14 and 15, the lower housing 615, the middle housing 616, and the upper housing 617 are stacked in a direction, and the lower housing 615 includes a plurality of the interlocking members 6151 and the middle housing 616 includes a plurality of first interlocking members 6161, wherein the interlocking members 6151 of the lower housing 615 and the first interlocking members 6161 of the middle housing 616 are arranged between the first and second lower receiving slots 611 and 612, and are in a hooked engagement with one another in the direction. Similarly, the middle housing 616 includes a plurality of second interlocking members 6162 and the upper housing 617 includes a plurality of the interlocking members 6171, wherein the second interlocking members 6162 of the middle housing 616 and the interlocking members 6171 of the upper housing 617 are arranged between the first and second upper receiving slots 613 and 614, and are in a hooked engagement with one another in the direction.

In summary, the electrical connector of one embodiment for receiving multiple electronic devices positioned in a stacked manner includes a pair of first arm members for latching one electronic device and a pair of second arm members for latching another electronic device. Each of the first and second arm members has an interfering portion, and the interfering portion of the lower of the two adjacent first and second arm members engages with the interfering portion of the upper of the two adjacent first and second arm members when the lower of the two adjacent first and second arm members moves toward an unlatched position so that both electronic devices positioned in a stacked manner can be simultaneously unlatched, and the situation where the lower electronic device is unlatched while the upper electronic device is latched can be avoided. In addition, each of the first and second arm members may further comprise a pressing portion for holding the inserted electronic device. The pressing portion of the lower of the first and second arm members protrudes inward further than the pressing portion of the upper of the first and second arm members, so that the upper electronic device can be unlatched prior to the lower electronic device. Furthermore, the unlatching movement of each of the first and second arm members can be limited by an arm member protector so as to prevent the first or second arm member from being damaged.

The above-described embodiments are intended to be illustrative only. Numerous alternative embodiments may be devised by persons skilled in the art without departing from the scope of the following claims.

What is claimed is:

1. A electrical connector, comprising:
a main body including two opposite ends, a front side having a lower region and an upper region, a first receiving slot formed on the lower region, and a second receiving slot formed on the upper region;
a pair of first arm members extending respectively from the two opposite ends, each first arm member including an interfering portion, wherein the lower region extends between the pair of first arm members; and
a pair of second arm members extending respectively from the two opposite ends, each second arm member including an interfering portion engageable with the interfering portion of the respective first arm member when the respective first arm member moves toward an unlatched position, wherein the upper region extends between the pair of second arm members.

2. The electrical connector of claim 1, further comprising a plurality of first lower and upper terminals each including a contact portion partially extending within the first receiving slot for electrically engaging a first type of electronic device and a solder portion solderable to a printed circuit board, and a plurality of lower and upper second terminals each including a contact portion partially extending within the second receiving slot for electrically engaging another first type of electronic device and a solder portion solderable to the printed circuit board.

3. The electrical connector of claim 2, wherein the first type of electronic device is a card edge module or a daughter card.

4. The electrical connector of claim 3, wherein each first arm member further comprises a pressing portion protruding inward to hold the first type of electronic device in an inserted position, and each second arm member comprises a pressing portion protruding inward to hold the another first type of electronic device in an inserted position, wherein a distance between an inward edge of the pressing portion of the first arm member and an adjacent edge of the first type of electronic device is greater than a distance between an inward edge of the pressing portion of the second arm member and an adjacent edge of the another first type of electronic device.

5. The electrical connector of claim 4, further comprising a pair of arm member protectors each disposed adjacent to the respective first and second arm members for limiting the unlatching movement of the first and second arm members.

6. The electrical connector of claim 5, further comprising a pair of screw elements, wherein each screw element fastens the respective arm member protector to the printed circuit board.

7. The electrical connector of claim 1, further comprising:
a plurality of first lower and upper terminals each including a first contact portion and a second contact potion; and
a plurality of second lower and upper terminals each including a first contact portion and a second contact portion;
wherein the main body further comprises a third receiving slot opposite the first receiving slot and a fourth receiving slot opposite the second receiving slot;
wherein the first contact portions of the first lower and upper terminals are arranged along the first receiving slot and configured for electrically engaging a first type of electronic device, the second contact portions of the first lower and upper terminals are arranged along the third receiving slot for electrically engaging a second type of electronic device, the first contact portions of the second lower and upper terminals are arranged along the second receiving slot for electrically engaging another first type of electronic device, and the second contact portions of the second lower and upper terminals are arranged along the fourth receiving slot for electrically engaging another second type of electronic device.

8. The electrical connector of claim 7, wherein the first type of electronic device is a card edge module or a daughter card, and the second type of electronic device is a flexible flat cable, flexible printed circuit board or mother card.

9. The electrical connector of claim 8, wherein each first arm member further comprises a pressing portion protruding inward to hold the first type of electronic device in an inserted position, and each second arm member comprises a pressing portion protruding inward to hold the another first type of electronic device in an inserted position, wherein a distance between an inward edge of the pressing portion of the first arm member and an adjacent edge of the first type of electronic device is greater than a distance between an inward edge of the pressing portion of the second arm member and an adjacent edge of the another first type of electronic device.

10. The electrical connector of claim 9, wherein the main body comprises a lower housing, a middle housing stacked on the lower housing, and an upper housing stacked on the middle housing, wherein the lower and middle housings combine to define the first and third receiving slots, and the middle and upper housings combine to define the second and fourth receiving slots.

11. The electrical connector of claim 10, wherein each of the first lower and upper terminals and the second lower and upper terminals comprises a transverse protrusion insertable into the respective one of the lower, middle, and upper housings.

12. The electrical connector of claims 11, wherein the lower housing, the middle housing, and the upper housing are stacked in a direction, and the lower housing includes a plurality of the interlocking members and the middle housing includes a plurality of first interlocking members, wherein the interlocking members of the lower housing and the first interlocking members of the middle housing are arranged between the first and third receiving slots, and are in a hooked engagement with one another in the direction; the middle housing includes a plurality of second interlocking members and the upper housing includes a plurality of the interlocking members, wherein the second interlocking members of the middle housing and the interlocking members of the upper housing are arranged between the second and fourth receiving slots, and are in a hooked engagement with one another in the direction.

13. The electrical connector of claim 12, further comprising a pair of arm member protectors each disposed adjacent to the respective first and second arm members for limiting the unlatching movement of the first and second arm members.

14. The electrical connector of claim 13, further comprising a pair of screw elements, wherein each screw element fastens the respective arm member protector to the printed circuit board.
